(19) United States
(12) Patent Application Publication
(10) Pub. No.: US 2005/0025345 A1
(43) Pub. Date: Feb. 3, 2005

(54) Non-contact information input device

(75) Inventors: Yoshimi Ohta, Yokosuka-shi (JP); Masaki Hirota, Zushi-shi (JP); Masafumi Tsuji, Yokosuka-shi (JP); Makoto Iwashima, Yokosuka-shi (JP); Yuuichi Igari, Atsugi-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Nissan Motor Co., Ltd., Yokohama (JP)

(21) Appl. No.: 10/883,852

(22) Filed: Jul. 6, 2004

(30) Foreign Application Priority Data
Jul. 30, 2003 (JP) JP 2003-282380

(51) Int. Cl. G06K 9/20; G06K 9/00

(52) U.S. Cl. 382/116; 382/317

(57) ABSTRACT

A non-contact information input device is provided that can easily and reliably use simple image processing to input information indicated by the shape of a user's hand. The non-contact information input device is configured to detect a user's hand using an imaging section, and to select an operation mode based on a shape of the hand. Then, a distance detecting section of the non-contact information input device is configured to detect a distance from the hand to the imaging section and adjust a parameter used in the operation mode in response to the distance if the parameter is adjustable. Thus, the image processing load is reduced and the parameter is easily and reliably adjusted by adjusting the parameter in the selected operation mode based on the distance detected by the distance detecting section.

### BACKGROUND OF THE INVENTION

1. Field of the Invention

The present invention relates to a non-contact information input device configured to input information for operating a device in a non-contact manner.

2. Background Information

In recent years, automobiles have been equipped with many types of information devices and electronic devices such as car navigation systems, audio equipment, televisions, video devices, cellular telephones and air conditioners. Moreover, an occupant of an automobile can not only receive telephone calls in the automobile, but also send, receive, read or write e-mail and access the Internet in the automobile. A trend of equipping automobiles with various electronic devices will further continue in the future as automatic payment receipt systems and driving safety support systems are introduced into automobiles. In other words, automobiles are about to become driving computers.

In order to operate those various electronic devices installed in an automobile, operation buttons for car audio, operation buttons for air conditioners, operation buttons for car navigation and/or various operation buttons and switches of remote controls are usually provided. In other words, these buttons and switches have been used to operate the devices on automobiles. As the number of devices installed in an automobile increases, the number of operations performed by users of the automobile to operate these devices dramatically increases. In particular, the variety of operations has greatly increased due to the introduction of car navigation systems.

Since operating devices installed in an automobile can cause a driver of the automobile to not look ahead carefully, it is preferable to construct the devices installed in automobiles to be able to be operated while an operator is looking ahead. For example, Japanese Laid-Open Patent Publication No. 2001-216069 discloses an operation input device using a non-contact control input switch in which the device can be operated while the operator is looking ahead. In the above mentioned reference, the operation input device uses a camera to perceive a shape of a hand (e.g., shape of fingers) and movement of the hand. The operation input device also includes a control input section that provides different operation modes corresponding to different shapes of the hand and different movements of the hand by detecting the shape of the hand and the movement of the hand by the camera.

In addition to switch between turning on/off a device (e.g., an air conditioner or a radio), adjusting a parameter such as air conditioner temperature or an audio volume can also be performed using hand gestures in the conventional operation input device in the above mentioned reference.

In view of the above, it will be apparent to those skilled in the art from this disclosure that there exists a need for an improved non-contact information input device. This invention addresses this need in the art as well as other needs, which will become apparent to those skilled in the art from this disclosure.

### SUMMARY OF THE INVENTION

It has been discovered when the conventional operation input device as described in the above mentioned reference is used, as the number of operation mode selections and parameter adjustments increases, the number of the shape of the hand and the movement of the hand (hand gestures) that correspond to each mode selection and each parameter adjustment also increases. Thus, mistakes in recognizing the shape of the hand and the movement of the hand easily occur, and the processing for recognizing the shape of the hand and the movement of the hand using image processing becomes complicated. Moreover, since the time required for processing becomes longer as the image processing becomes more complicated, the processing is unable to sufficiently follow the movements of the hand.

Accordingly, one object of the present invention is to solve the problems mentioned above and provide a non-contact information input device that can easily and reliably use relatively simple image processing to input information indicated by a shape of a user's hand.

In order to achieve the above mentioned and other objects of the present invention, a non-contact information input device is provided that basically comprises an imaging section, a shape detecting section, an operation mode selecting section, a distance detecting section and a parameter adjusting section. The imaging section is configured and arranged to capture an image of a prescribed imaging region including an object. The shape detecting section is configured and arranged to detect a shape of the object based on the image obtained by the imaging section. The operation mode selecting section is configured and arranged to select a prescribed operation mode based on a detection result of the shape detecting section. The distance detecting section is configured and arranged to detect a distance between the imaging section and the object. The parameter adjusting section is configured and arranged to adjust a value of at least one adjustable parameter used in the prescribed operation mode to obtain an adjusted value according to the distance detected by the distance detecting section.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a block diagram illustrating a basic configuration of a non-contact information input device in accordance with a first embodiment of the present invention;

FIG. 2 is a diagrammatic view for illustrating imaging a hand of a user by an infrared camera of the non-contact information input device in accordance with the first embodiment of the present invention;

FIG. 3 is a diagrammatic view for illustrating examples of several relationships between hand shapes and operation mode selections in accordance with the first embodiment of the present invention;

FIG. 4 is a diagrammatic view illustrating a positional relationship between the hand of the user and the infrared camera of the non-contact information input device in accordance with the first embodiment of the present invention;

FIG. 5 is a block diagram illustrating a basic configuration of a distance detecting section of the non-contact information input device in accordance with the first embodiment of the present invention;

FIG. 6 is a flowchart for explaining a control flow executed in the non-contact information input device in accordance with the first embodiment of the present invention;

FIG. 7 is a block diagram illustrating a basic configuration of a distance detecting section configured to detect a distance based on an area of a hand in an image obtained by an infrared camera of a non-contact information input device in accordance with a second embodiment of the present invention;

FIG. 8 is a diagrammatic view for illustrating a positional relationship between the hand of the user and the infrared camera of the non-contact information input device in accordance with the second embodiment of the present invention;

FIG. 9 is a diagrammatic view for illustrating various images at various positions of the hand of the user in accordance with the second embodiment of the present invention;

FIG. 10 is a block diagram illustrating a basic configuration of a non-contact information input device in accordance with a third embodiment of the present invention; and

FIG. 11 is a diagrammatic view for illustrating a positional relationship between a hand of a user, an electrostatic capacity sensor, and an infrared camera of the non-contact information input device in accordance with the third embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

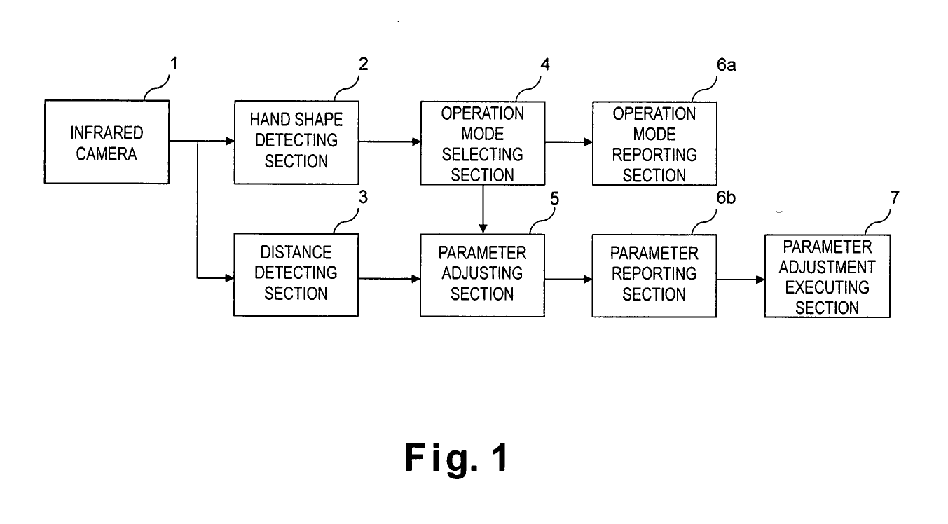

Referring initially to FIGS. 1-6, a non-contact information input device is illustrated in accordance with a first embodiment of the present invention. FIG. 1 is a block diagram illustrating a basic configuration of the non-contact information input device of the first embodiment. More specifically, the block diagram of FIG. 1 illustrates the non-contact information input device when the non-contact information input device according to the present invention is used to operate devices installed in an automobile. Of course, it will be apparent to those skilled in the art from this disclosure that the non-contact information input device of the present invention is not limited to operating devices installed in automobiles. Rather, the non-contact information input device can be adapted to operate any kind of device when information input in a non-contact manner for operating the device is desirable.

Basically, the non-contact information input device of the present invention is preferably configured to detect a shape of an object and select an operation mode of devices installed in an automobile based on the shape of the object, then a parameter used in the operation mode is adjusted based on a change in distance to the object. More specifically, the non-contact information input device of the first embodiment is preferably configured to detect a shape of a user's hand, and select one of a plurality of prescribed operation modes (e.g., adjusting air conditioning temperature, air volume, audio volume, and the like) that corresponds to the detected shape of the hand. Then, the non-contact information input device is preferably configured and arranged to detect a distance to the hand, and adjust at least one parameter used in the selected prescribed operation mode based on the distance detected. In the present invention, the distance to the hand is preferably detected as a change in a distance to the hand since the hand is initially detected.

As seen FIG. 1, the non-contact information input device of the first embodiment basically comprises an infrared camera 1, a hand shape detecting section 2, a distance detecting section 3, an operation mode selecting section 4, and a parameter adjusting section 5. The infrared camera 1 preferably constitutes an imaging section configured and arranged to capture an image of a hand of a user within a prescribed imaging region. The hand shape detecting section 2 is configured and arranged to detect a shape of the hand of the user that is held up in the direction of the infrared camera 1 based on the image obtained by the infrared camera 1. The distance detecting section 3 is configured and arranged to detect a distance between the hand and the infrared camera 1. The operation mode selecting section 4 is configured and arranged to select a prescribed operation mode of a device installed in the automobile based on a detection result of the hand shape detecting section 2.

More specifically, in the following description of the present invention, an air conditioner and an audio system are used as examples of devices that are installed in the automobile. Thus, the operation mode selecting section 4 is preferably configured and arranged to select one of a plurality of prescribed operation modes such as adjusting air conditioning temperature, adjusting air volume, adjusting audio volume, and the like. Of course, it will be apparent to those skilled in the art from this disclosure the non-contact information input device of the present invention is not limited to the use for these devices, or the prescribed operation modes are not limited to the examples explained above. Rather, the non-contact information input device can be utilized to operate any devices and any operation modes for the devices can be adapted as necessary.

The parameter adjusting section 5 is configured and arranged to adjust a parameter for the operation mode selected in the operation mode selecting section 4 to obtain an adjusted value of the parameter based on a detection result of the distance detecting section 3 when the parameter is adjustable. In the case of the air conditioner and the audio system, the parameters are, for example, an air conditioner temperature, an air conditioner fan speed, an audio volume, and the like. If a prescribed operation mode is only for switching or turning on/off a device (i.e., there is no adjustable parameter), then that operation is executed without executing the parameter adjustment operation.

Moreover, the non-contact information input device preferably further comprises an operation mode reporting section 6a, a parameter reporting section 6b, and a parameter adjustment executing section 7. The operation mode reporting section 6a is configured and arranged to report the operation mode selected by the operation mode selecting section 4 to the user. The parameter reporting section 6b is configured and arranged to report the adjusted value of the parameter adjusted by the parameter adjusting section 5 to the user. The parameter adjustment executing section 7 is configured and arranged to set a value of the parameter to the adjusted value of the parameter adjusted by the parameter adjusting section 5 before the control process ends when the parameter adjustment executing section 7 determines the user has accepted the adjusted value.

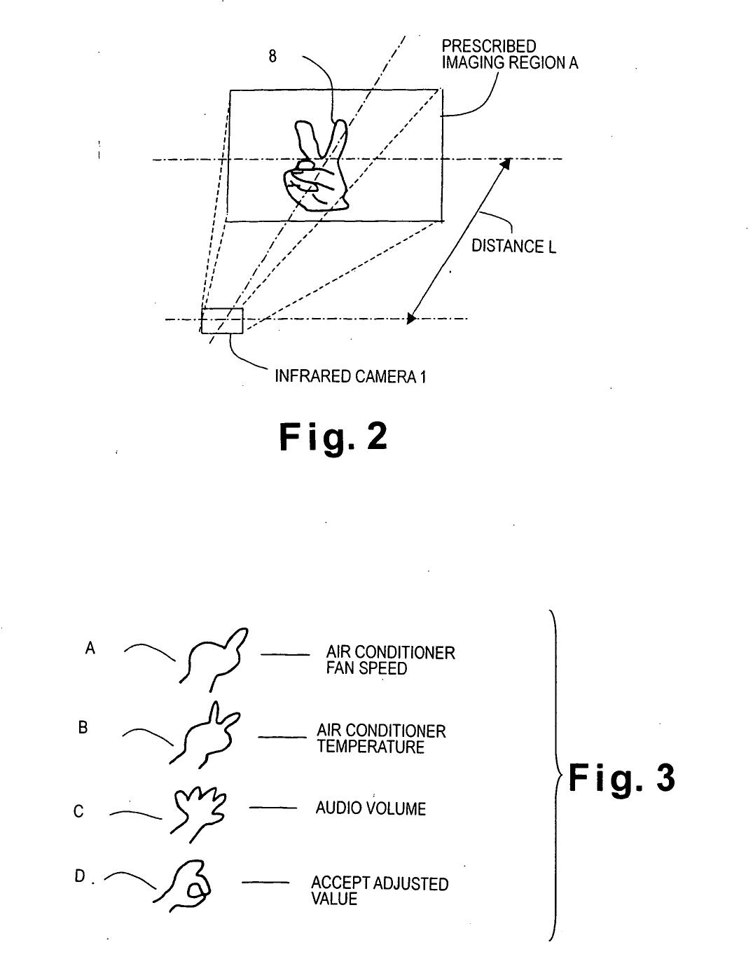

FIG. 2 is a diagrammatic view for illustrating imaging a user's hand 8 by the infrared camera 1 within a prescribed imaging region A. As seen in FIG. 2, when the user holds up the hand 8 within the prescribed imaging region A, the infrared camera 1 is configured and arranged to image the hand 8. A shape of the hand 8 is detected by the hand shape detecting section 2. The distance detecting section 3 is configured and arranged to substantially simultaneously detect a distance L between the hand 8 and the infrared camera 1.

Next, the operation mode selecting section 4 is configured and arranged to select a prescribed operation mode based on the shape of the hand 8. Then, the parameter adjusting section 5 is configured and arranged to adjust a value of a parameter that is adjustable used in the selected operation mode based on a change in the distance L due to a movement of the hand 8. For example, if the hand 8 is brought closer toward the infrared camera 1, the parameter adjusting section 5 is preferably configured and arranged to adjust the parameter by increasing the value of the parameter. If the hand 8 is moved farther away from the infrared camera 1, the parameter adjusting section 5 is preferably configured and arranged to adjust the parameter by decreasing the value of the parameter.

After the parameter is adjusted, the parameter adjustment executing section 7 is configured and arranged to determine whether the shape of the hand 8 matches a prescribed set shape based on the detection by the hand shape detecting section 2. The prescribed set shape is a shape of the hand 8 (e.g., forming a circle with the fingers) that indicates the user accepts the adjusted value of the parameter. If the detected shape of the hand 8 matches the prescribed set shape, the parameter adjustment executing section 7 is configured and arranged to execute an operation of the parameter adjustment by setting the value of the parameter to the adjusted value. If the detected shape of the hand 8 does not match the prescribed set shape, the parameter is not set to the adjusted value and the value of the parameter is returned to an original value before the adjustment operation. The parameter adjustment executing section 7 can also be configured and arranged to set the value of the parameter to the adjusted value when the hand shape detecting section 2 detects the hand 8 is moved out from the prescribed imaging region A of the infrared camera 1. In other words, the parameter adjustment executing section 7 can be configured and arranged to determine the user has accepted the adjusted value of the parameter when the user moves the hand 8 out of the prescribed imaging region A.

The operation mode selecting section 4 is configured and arranged to determine the shape of the hand 8 as described above based on the image obtained by the infrared camera 1 by using a conventional image processing. In the present invention, the infrared camera 1 can be substituted by a visible light camera utilized as a sensor for detecting both the shape of the hand 8 and the distance L. However, an infrared camera is generally better suited for detecting the shape of the hand 8 and the distance L for the non-contact information input device of the present invention, especially when the non-contact information input device is utilized with devices installed in an automobile. More specifically, since the inside of an automobile is bright during the day time and dark at night, there will be large fluctuations of the external light conditions inside the automobile. Thus, images obtained using a visible light camera will have large fluctuations, and thus, the detection accuracy of the non-contact information input device may be reduced. Consequently, an infrared camera that detects infrared rays is suitable because infrared rays are not easily influenced by disturbances of the external light condition. In particular, since an infrared camera that detects far-infrared rays can capture only objects that emit heat (i.e. hand) as an image, a shape of a hand held up in front of the infrared camera can be extracted with a high accuracy.

Next, examples of the correspondence between the detected shapes of the hand 8 and the operation mode selections of the devices installed in the automobile determined in the operation mode selecting section 4 will be described. As used herein, the shape of the hand refers to various shapes or forms that are expressed by a hand. For example, the shapes of the hand includes shapes such as “rock (fist)”, “scissors (two fingers)” and “paper (open hand)” in a game of paper-rock-scissors, as well as “different shapes formed by extending one or more of fingers among the five fingers” and “a shape with a circle formed by an index finger and a thumb”.

The diagrams A-D in FIG. 3 illustrate examples of the correspondence between various hand shapes and various operation mode selections. For example, the hand shape of the diagram A (one finger) indicates to select the operation mode for adjusting the air conditioner fan speed or an air volume, the hand shape of the diagram B (two fingers) indicates to select the operation mode for adjusting the air conditioner temperature and the hand shape of the diagram C (five fingers) indicates to select the operation mode for adjusting the audio volume. The diagram D shows the prescribed set shape (fingers forming a circle) that indicates to accept and execute an adjusted value of the parameter in the parameter adjustment executing section 7.

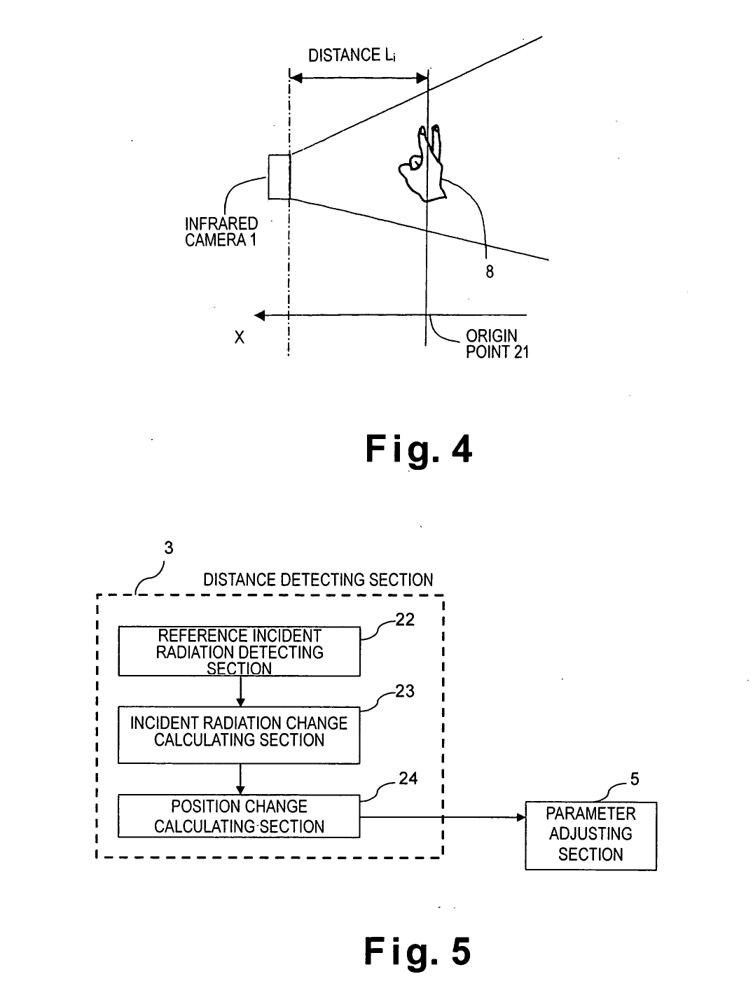

Next, the distance detecting section 3 and the parameter adjusting section 5 will be described in more detail. FIG. 4 shows a positional relationship between the infrared camera 1 and the user's hand 8. FIG. 5 is a block diagram showing a basic configuration of the distance detecting section 3. As seen in FIG. 5, the distance detecting section 3 basically comprises a reference incident radiation detecting section 22, an incident radiation change calculating section 23, and a position change calculating section 24.

When the infrared camera 1 perceives far-infrared rays from the hand 8, the infrared camera 1 captures a temperature distribution within the prescribed imaging region A due to the far-infrared rays as an image. As shown in FIG. 4, if the hand 8 is placed in front of the infrared camera 1, far-infrared rays corresponding to the temperature of the surface of the hand 8 are radiated and entered into the infrared camera 1. Consequently, an amount of incident radiation to the infrared camera 1 increases as the hand 8 gets closer to the infrared camera 1 and decreases as the hand 8 gets further away from the infrared camera 1. The amount of incident radiation to the infrared camera 1 is known to be inversely proportional to the square of the distance L between the hand 8 and the infrared camera 1.

In FIG. 4, a distance between the infrared camera 1 and the hand 8 when the shape of the hand 8 is detected by the hand shape detecting section 2 is set as an reference distance Lᵢ, and the position of the hand 8 when the shape of the hand 8 is detected by the hand shape detecting section 2 is set as an origin point 21. Then, an amount of incident radiation from the hand 8 to the infrared camera 1 when the shape of the hand 8 is initially detected by the hand shape detecting section 2 at the origin point 21 is calculated by the reference incident radiation detecting section 22 and the amount of incident radiation is set as a reference incident radiation amount I(0). If the hand 8 approaches toward the infrared camera 1 from the origin point 21 by a distance x, the incident light quantity I(x) is calculated by the following Equation 1.

$$I ( x ) = I ( 0 ) ( \frac{{L}_{i}^{2}}{{( {L}_{i} - x )}^{2}} ) \qquad Equation 1$$

Then, a change in the incident radiation amount (i.e., I(x)−I(0)) from the reference incident radiation amount I(0) is calculated in the incident radiation change calculating section 23 using the following Equation 2.

$$\begin{matrix}I ( x ) - I ( 0 ) = I ( 0 ) ( \frac{{L}_{i}^{2}}{{( {L}_{i} - x )}^{2}} - 1 ) \\ = I ( 0 ) ( \frac{1}{{( 1 - \frac{x}{{L}_{i}} )}^{2}} - 1 )\end{matrix} \qquad Equation 2$$

Then, the distance x (a change in the distance from the origin point 21) is calculated from the value I(x)−I(0) mentioned above in the position change calculating section 24. Then, the parameter adjusting section 5 is preferably configured to adjust the parameter used in the selected operation mode such that if the distance x becomes positively larger (the hand 8 moves closer to the infrared camera 1 than the origin point 21), the parameter will become larger, and if the distance x becomes negatively larger (the hand 8 moves farther away from the infrared camera 1 than the origin point 21), the parameter will become smaller. Thus, the distance x can be obtained as a relative value either closer to or farther from a reference position (the origin point 21) without calculating an absolute distance value between the hand 8 and the infrared camera 1. In other words, a difference or a change ratio with respect to the distance at the reference position (i.e. the reference distance Lᵢ at the origin point 21) is detected by the distance detecting section 3, and the parameter is adjusted based on the detection result of the distance detecting section 3.

Next, one of the functions of the non-contact information input device of the present invention for reporting to the user details concerning which operation mode is selected and how much the parameter is adjusted will be described. More specifically, the operation mode reporting section 6a and the parameter reporting section 6b are configured and arranged to report to the user operation details using, for example, audio signals such as voices and sounds, or optical signals.

For example, when the “air conditioner fan speed operation mode” is selected as the user indicates the shape of the hand 8 shown in the diagram A in FIG. 3, the operation mode reporting section 6a is configured and arranged to issue an audio sound indicating “air conditioner fan speed” to report to the user of the selected operation mode. Then, the operation mode is switched to the operation mode for adjusting the air conditioner fan speed. Then, the user can change the air conditioner fan speed by changing the distance between the hand 8 and the infrared camera 1. In other words, the parameter used in the “air conditioner fan speed operation mode”, i.e., the fan speed, is changed by the user by moving the hand 8 while the user actually perceives a change in the air conditioner fan speed. Thus, the user can adjust the air conditioner fan speed to a desired speed.

When the “air conditioner temperature operation mode” is selected as the user indicates the shape of the hand 8 shown in the diagram B in FIG. 3, the operation mode reporting section 6a issues an audio sound indicating “air conditioner temperature” to report to the user of the selected operation mode. Then, the operation mode is switched to the operation mode for adjusting the air conditioner temperature. Although the adjustment of the air conditioner temperature is performed by changing the position of the hand 8 with respect to the infrared camera 1 as in the adjustment of the air conditioner fan speed, the temperature usually does not change quickly. In other words, it is difficult for the user to perceive the change in the temperature as the parameter used in the air conditioner temperature operation mode, i.e., the temperature, changes. Accordingly, the parameter reporting section 6b is preferably configured and arranged to issue a “beep” sound each time the parameter (the temperature) changes by a unit of 0.5° C. In such case, if the user ceases the adjustment of the parameter (i.e., the hand 8 stops moving), the temperature set at the end of the adjustment will be pronounced and reported to the user as, for example, “25 degrees”. Consequently, the user is able to verify the adjusted value of the parameter (e.g., temperature setting). Moreover, the user is able to verify the details of the parameter adjustment without looking away from the driving direction since the non-contact information input device is configured to report the parameter adjustment information using audio signals such as voices and sounds as described above.

When “the audio volume operation mode” is selected as the user indicates the shape of the hand 8 shown in the diagram C in FIG. 3, the operation mode reporting section 6a is configured and arranged to issue an audio sound indicating “audio volume” to report to the user of the selected operation mode. Then, the operation mode is switched to the operation mode for adjusting the audio volume. As the above explained air conditioning fan speed adjustment, the audio volume adjustment is performed by changing the position of the hand 8 with respect to the infrared camera 1. In the case of the audio volume adjustment, the user is able to actually perceive the sound being louder or smaller as the parameter used in the audio volume operation mode, i.e., the audio volume, is adjusted. Therefore, the user can adjust the volume to a desired level.

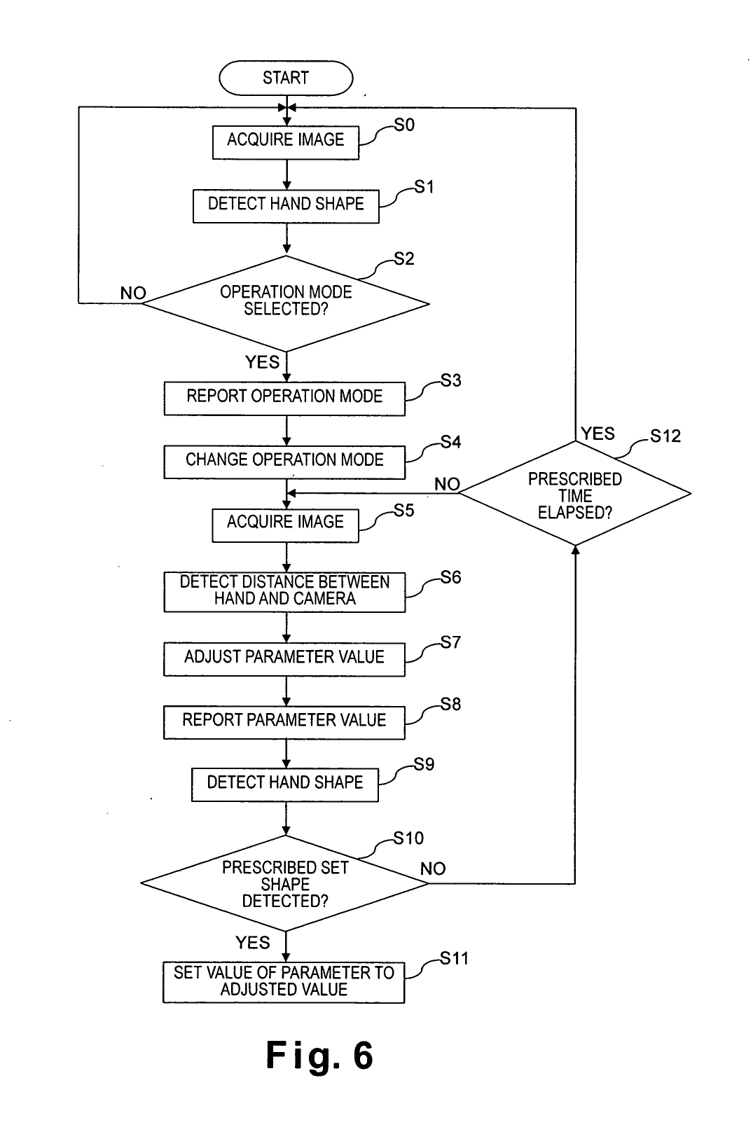

FIG. 6 is a flowchart for a control flow executed by the non-contact information input device of the present invention. In step S0 in FIG. 6, information of an area within the prescribed imaging region A is acquired by the infrared camera 1. Then, in step S1, the shape of the hand 8 that is held up toward the infrared camera 1 is detected by the hand shape detecting section 2. In step S2, the operation mode selecting section 4 is configured and arranged to determine whether the detected shape of the hand 8 matches any of the prescribed shapes (e.g., the diagrams A-D in FIG. 3). If the detected shape of the hand 8 does not match any of the prescribed shapes (NO in step S2), the process returns to step S0.

If the detected shape of the hand 8 matches one of the prescribed shapes (e.g., the diagrams A-D in FIG. 3) (YES in step S2), the operation mode reporting section 6a is configured and arranged to report the operation mode selected based on the detected shape of the hand 8 to the user in step S3. Then, the operation mode is switched in step S4. An image of the hand 8 is acquired in step S5 once again by using the infrared camera 1.

In step S6, the distance from the image acquired in step S5 is measured by the distance detecting section 3. Then, in step S7 the parameter value is adjusted by the parameter adjusting section 5 as the distance between the hand 8 and the infrared camera 1 changes. The operation mode reporting section 6a is configured and arranged to report the adjusted value of the parameter to the user in step S8.

Next, the shape of the hand 8 is detected again in step S9 by the hand shape detecting section 2. Then, a determination is made in step S10 as to whether the detected shape of the hand 8 matches the prescribed set shape which is a shape of the hand that indicates to accept the adjusted value of the parameter (e.g., the diagram D in FIG. 3). As mentioned above, the non-contact information input device of the present invention can also be configured to detect whether the hand 8 moved out of the prescribed imaging region A in step S9 to determine whether the user accepts the adjusted value of the parameter.

If the detected shape of the hand 8 matches the prescribed set shape (YES in step S10), the value of the parameter is set to the adjusted value in step S11. If the detected shape of the hand 8 is determined not to match the prescribed set shape (NO in step S10), the process proceeds to step S12. In step S12, if a prescribed time has not yet elapsed (NO in step S12), the processing returns to step S5. On the other hand, if the prescribed set shape is not detected (e.g., the detected shape of the hand 8 does not match the prescribed set shape) after the prescribed time has elapsed (YES in step S12), the non-contact information input device is configured to determine the input of the operation was erroneous (such as when a shape of the hand 8 similar to the prescribed shape was accidentally imaged by the infrared camera 1) and the process returns to step S0.

Accordingly, with the non-contact information input device of the present invention as being utilized for operating the devices installed in the automobile, the infrared camera 1 is configured and arranged to detect the hand 8 and the operation mode selecting section 4 is configured and arranged to select the operation mode of the device installed in the automobile from the shape of the hand 8. If it is required to adjust a parameter depending on the selected operation mode, the parameter can be easily and reliably adjusted without complex image processing by calculating the distance x based on the value of the incident radiation amount I(x) from the hand 8 to the infrared camera 1. Furthermore, the incident radiation amount from the hand 8 becomes larger as the distance between the hand 8 and the infrared camera 1 becomes smaller, and the incident radiation amount becomes smaller as the distance between the hand 8 and the infrared camera 1 becomes larger. Therefore, the distance between the hand 8 and the infrared camera 1 with respect to the reference distance can be easily determined by detecting the incident radiation amount in the distance detecting section 3.

Also, the non-contact information input device of the present invention preferably comprises the operation mode reporting section 6a and the parameter reporting section 6b to notify the user of the selected operation mode and the parameter value while adjusting the parameters. Therefore, the user can verify the parameter value at anytime during the operation. The user can also reliably adjust the parameter value to a desired value by using the adjustment executing section 7 to accept and execute the parameter value using the prescribed set shape of the hand 8.

In addition, since acceptance of parameter adjustment by the user is determined using the prescribed set shape of the hand 8, the user's intention can be reliably reflected and an operation of the device that is not intended by the user can be prevented.

In the first embodiment of the present invention, the infrared camera 1 preferably constitutes an imaging section. Of course, it will be apparent to those skilled in the art from this disclosure that the imaging section is not limited to an infrared camera (far-infrared or near-infrared). For example, a visible light camera can also be utilized to constitute the imaging section of the present invention.

As described above, the first embodiment of the present invention has the effect of reducing the image processing load and allowing the operation parameter to be easily and reliably adjusted by adjusting parameter value in the selected operation mode based on a distance detected by the distance detecting section 3.

### Second Embodiment

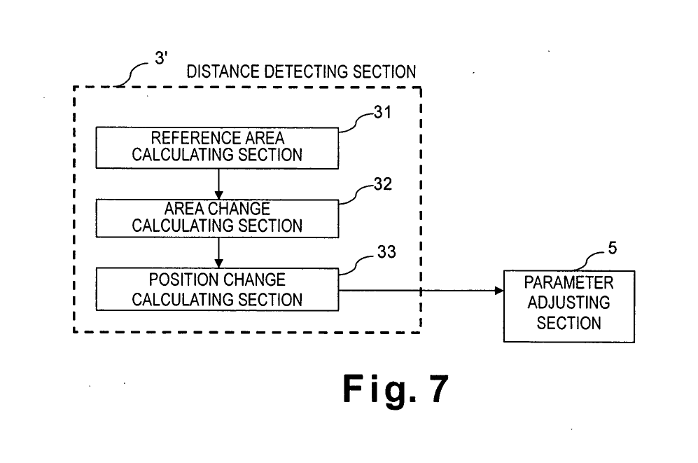

Referring now to FIGS. 7-9, a non-contact information input device in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with a single prime (′).

Basically, the non-contact information input device of the second embodiment is identical to the first embodiment except a distance detecting section 3′ is configured and arranged to calculate a distance between the infrared camera 1 and the hand 8 from an area occupied by the hand 8 in an image of the prescribed imaging region A. Other sections of the non-contact information input device of the second embodiment are identical the first embodiment shown in FIG. 1. Moreover, since the control process in the second embodiment is identical to the control process in the first embodiment shown in the flowchart of FIG. 6, a detail description the control process of second embodiment is omitted.

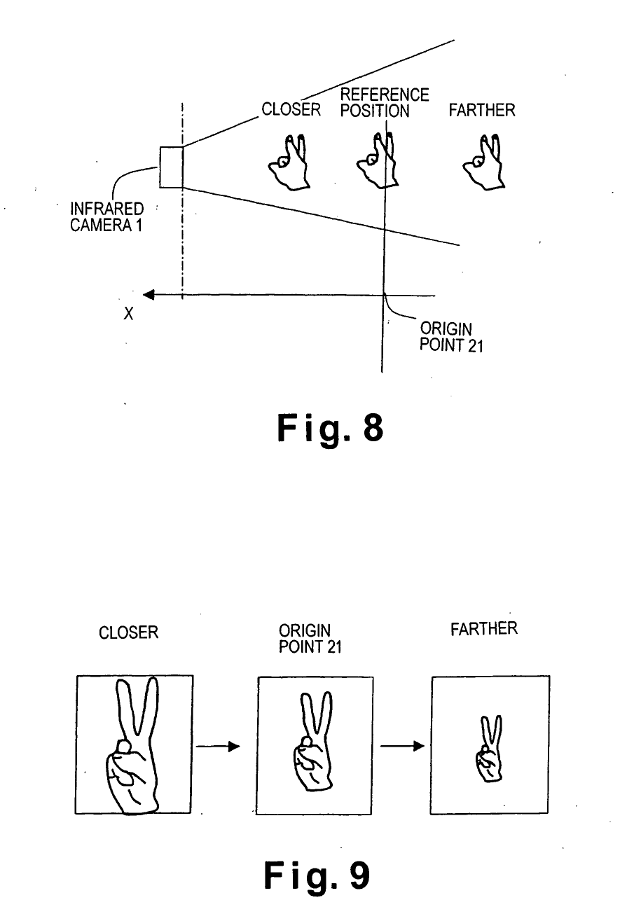

FIG. 7 is a block diagram showing a basic configuration of the distance detecting section 3′ of the second embodiment. The distance detecting section 3′ is configured to detect the distance between the hand 8 and the infrared camera 1 with respect to the reference distance based on an area of the hand 8 occupied in the image obtained by the infrared camera 1. FIG. 8 shows the positional relationship between the infrared camera 1 and the hand 8. FIG. 9 shows different sizes of the hand 8 in the image depending on the position of the hand 8. As seen in FIG. 7, the distance detecting section 3′ basically comprises a reference area calculating section 31, an area change calculating section 32, and a position change calculating section 33.

An object imaged by a camera is usually shown to grow larger as the object approaches closer to the camera. Thus, the distance detecting section 3′ is configured to utilize this property (i.e., the size of the object changes as the distance changes) to calculate a distance between the hand 8 and the infrared camera 1.

As shown in FIG. 8, the reference area calculating section 31 is configured to set an reference area A(0) to an area occupied by the hand 8 in an image of the prescribed imaging area A when the operation mode selecting section 4 first determines the prescribed operation mode is selected. A distance between the infrared camera 1 and the hand 8 when the operation mode selecting section 4 first determines the prescribed operation mode is selected set as a reference distance Lᵢ. The position of the hand 8 when the operation mode selecting section 4 first determines the prescribed operation mode is set as an origin point 21. If the hand 8 moves from the origin point 21 approaching the infrared camera 1 by a distance x, a ratio of the area A(x) occupied by the hand 8 in the image of the prescribed imaging region A is calculated by the following Equation 3.

$$A ( x ) = A ( 0 ) ( \frac{{L}_{i}^{2}}{{( {L}_{1} - x )}^{2}} ) \qquad Equation 3$$

A change of the area occupied by the hand 8 in the image of the prescribed imaging region A is calculated in the area change calculating section 32. In other words, an amount of change A(x)−A(0) from the reference area A(0) can be calculated using the following Equation 4.

$$\begin{matrix}A ( x ) - A ( 0 ) = A ( 0 ) ( \frac{{L}_{i}^{2}}{{( {L}_{i} - x )}^{2}} - 1 ) \\ = A ( 0 ) ( \frac{1}{{( 1 - \frac{x}{{L}_{i}} )}^{2}} - 1 )\end{matrix} \qquad Equation 4$$

A position change calculating section 35 is configured to calculate the distance change x from the value of A(x)−A(0) calculated in by the area change calculating section 32. Since the position of the hand 8 can be detected either approaching close to or moving farther away with respect to the reference distance Lᵢ, the value of the parameter that is to be adjusted is adjusted according to the amount of change of the distance x.

As shown in FIG. 9, when the hand 8 approaches close to the infrared camera 1 from the origin point 21, the area of the hand 8 in the image of the prescribed imaging area A becomes larger. When the hand 8 moves farther away from the infrared camera 1 from the origin point 21, the area of the hand 8 in the image becomes smaller. Thus, the parameter adjusting section 5 is preferably configured to adjust the parameter used in the selected operation mode such that if the distance x becomes positively larger (the hand 8 moves closer to the infrared camera 1 than the origin point 21), the parameter will become larger, and if the distance x becomes negatively larger (the hand 8 moves farther away from the infrared camera 1 from the origin point 21), the parameter will become smaller. Thus, the distance x can be obtained as a relative value either closer to or farther from a reference position (the origin point 21) without calculating an absolute distance value between the hand 8 and the infrared camera 1. In other words, a difference or a change ratio with respect to the distance at the reference position (i.e. the reference distance Lᵢ at the origin point 21) is detected by the distance detecting section 3′, and the parameter is adjusted based on the detection result of the distance detecting section 3′.

The area ratio of the image of the hand 8 occupying in the image of the prescribed imaging region A becomes larger as the distance L between the hand 8 and the infrared camera 1 becomes closer. The ratio becomes smaller as the distance L between the hand 8 and the infrared camera 1 becomes farther. Consequently, the distance L between the hand 8 and the infrared camera 1 can be easily calculated by calculating the area of the hand 8 in the image. Therefore, the third embodiment of the present invention has the effect of making it possible to easily adjust the parameter used in the selected embodiment from the area of the hand 8 by calculating the area of the hand 8 that occupies in the image of the prescribed imaging region A.

### Third Embodiment

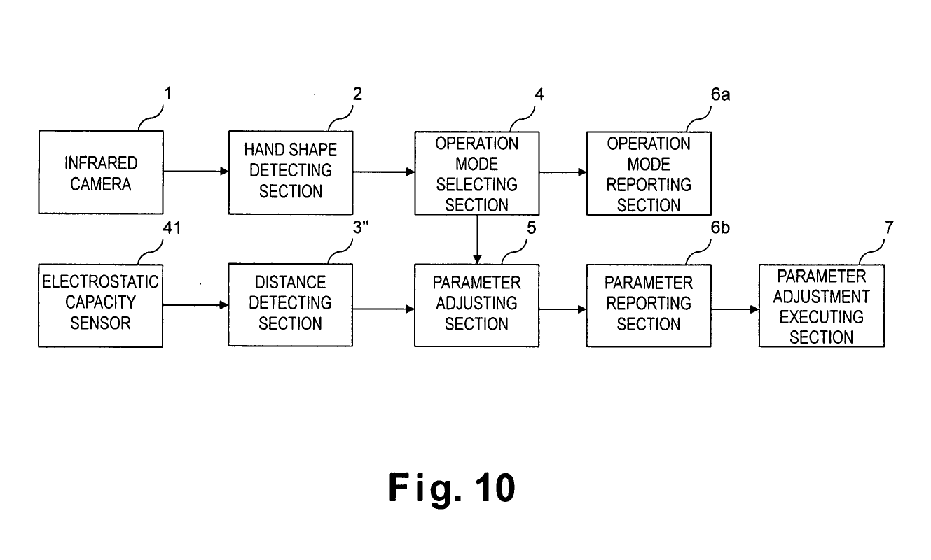

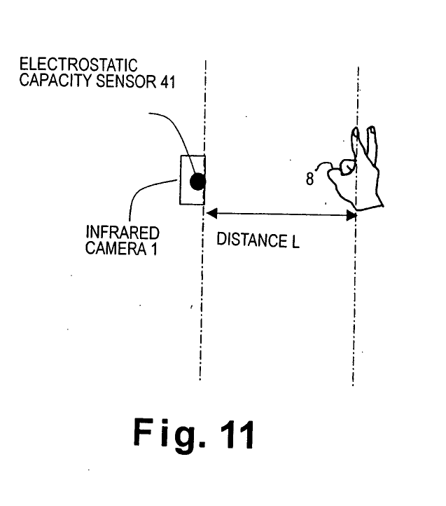

Referring now to FIGS. 10 and 11, a non-contact information input device in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity. The parts of the third embodiment that differ from the parts of the first embodiment will be indicated with a double prime (″).

FIG. 10 is a block diagram illustrating a basic configuration of a non-contact information input device in accordance with the third embodiment of the present invention. The third embodiment of the present invention is basically identical to the first embodiment except the third embodiment further comprises a electrostatic capacity sensor 41 and a distance detecting section 3″ is configured to detect a distance between the hand 8 and the infrared camera 1 by using the detection result from the electro static capacity sensor 41. In other words, in FIG. 10, the operations of the infrared camera 1, the hand shape detecting section 2, the operation mode selecting section 4, the operation mode reporting section 6a, the parameter reporting section 6b, the parameter adjustment executing section 7 are identical to the operations explained in the first embodiment. Moreover, the control process of the third embodiment is substantially identical to the control process of the first embodiment illustrated in the flowchart of FIG. 6.

As shown in FIG. 11, the electrostatic capacity sensor 41 is preferably disposed substantially adjacent to the infrared camera 1. The distance detecting section 3″ is configured to detect changes in the electrostatic capacity caused by the movement of the hand 8 based on the detection results from the electrostatic capacity sensor 41. The electrostatic capacity from the hand 8 varies in response to the distance L between the electrostatic capacity sensor 41 and the hand 8. Thus, the distance L between the infrared camera 1 and the hand 8 is detected in response to a change in the electrostatic capacity. In the same manner as the first and second embodiments, a position of the hand 8 and a distance to the infrared camera 1 when the operation mode selecting section 4 first determines the prescribed shape of the hand is detected is set to a reference position and a reference distance, respectively. Then, the parameter used in the selected operation mode is adjusted in response to whether the position of the hand 8 moves closer to the infrared camera 1 or farther away from the infrared camera 1 with respect to the reference position. Thus, the parameter can be adjusted with a good accuracy.

According to the third embodiment, the electrostatic capacity sensor 41 makes it possible to detect with good accuracy the distance between the hand 8 and the electrostatic capacity sensor 41. By installing the electrostatic capacity sensor 41 substantially adjacent to the infrared camera 1, the distance between the infrared camera 1 and the hand 8 can be easily determined. Thus, the parameter is effectively adjusted with good accuracy by detecting a change in the distance when the hand 8 is moved while the parameter is adjusted.

As used herein, the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2003-282380. The entire disclosure of Japanese Patent Application No. 2003-282380 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A non-contact information input device comprising:
an imaging section configured and arranged to capture an image of a prescribed imaging region including an object;
a shape detecting section configured and arranged to detect a shape of the object on the image obtained by the imaging section;
an operation mode selecting section configured and arranged to select a prescribed operation mode based on a detection result of the shape detecting section;
a distance detecting section configured and arranged to detect a distance between the imaging section and the object; and
a parameter adjusting section configured and arranged to adjust a value of at least one adjustable parameter used in the prescribed operation mode to obtain an adjusted value according to the distance detected by the distance detecting section.

2. The non-contact information input device as recited in claim 1, wherein
the shape detecting section is configured to detect a shape of a hand of a user within the prescribed imaging region of the imagining section as the shape of the object.

3. The non-contact information input device as recited in claim 1, further comprising
a reporting section configured and arranged to report the user the prescribed operation mode selected by the operation mode selecting section and a value of the at least one adjustable parameter adjusted by the parameter adjusting section by using at least one of audio signals and optical signals.

4. The non-contact information input device as recited in claim 1, further comprising
a parameter adjustment executing section configured and arranged to set the value of the at least one adjustable parameter to the adjusted value when the shape of the object detected by the shape detecting section matches a prescribed set shape.

5. The non-contact information input device as recited in claim 3, further comprising
a parameter adjustment executing section configured and arranged to set the value of the at least one adjustable parameter to the adjusted value when the shape of the object detected by the shape detecting section matches a prescribed set shape.

6. The non-contact information input device as recited in claim 1, further comprising
a parameter adjustment executing section configured and arranged to set the value of the at least one adjustable parameter to the adjusted value when the shape detecting section detects the object is moved out from the prescribed imaging region of the imaging section.

7. The non-contact information input device as recited in claim 1, wherein
the distance detecting section is further configured and arranged to calculate the distance between the imaging section and the object based on an amount of incident radiation from the object to the imaging section.

8. The non-contact information input device as recited in claim 1, wherein
the distance detecting section is further configured and arranged to calculate the distance between the imaging section and the object based on an area occupied by the object in the prescribed imaging region of the imaging section.

9. The non-contact information input device as recited in claim 1 further comprising
an electrostatic capacity sensor provided substantially adjacent to the imaging section, and
the distance detecting section is further configured to calculate the distance between the imaging section and the object based on a change in electrostatic capacity detected by the electrostatic capacity sensor.

10. The non-contact information input device as recited in claim 1, wherein
the distance detecting section is further configured and arranged to set a reference distance to a distance when the object is initially detected by the shape detecting section, and to determine the distance between the imaging section and the object as a relative change with respect to the reference distance.

11. The non-contact information input device as recited in claim 7, wherein
the distance detecting section is further configured and arranged to set a reference distance to a distance when the object is initially detected by the shape detecting section, and to determine the distance between the imaging section and the object as a relative change with respect to the reference distance.

12. The non-contact information input device as recited in claim 8, wherein
the distance detecting section is further configured and arranged to set a reference distance to a distance when the object is initially detected by the shape detecting section, and to determine the distance between the imaging section and the object as a relative change with respect to the reference distance.

13. The non-contact information input device as recited in claim 9, wherein
the distance detecting section is further configured and arranged to set a reference distance to a distance when the object is initially detected by the shape detecting section, and to determine the distance between the imaging section and the object as a relative change with respect to the reference distance.

14. The non-contact information input device as recited in claim 1, wherein
the imaging section includes an infrared camera.

15. A method of inputting information in non-contact manner comprising:
capturing an image of a prescribed imaging region including an object;
detecting a shape of the object based on the image;
selecting a prescribed operation mode based on the shape of the object;
detecting a change in a distance to the object with respect to a reference position; and
adjusting a value of at least one parameter used in the prescribed operation mode to obtain an adjusted value according to the distance to the object.

16. The method as recited in claim 15, wherein
the detecting the shape of the object includes detecting a shape of a hand of a user within the prescribed imaging region.

17. A non-contact information input device comprising:
imaging means for capturing an image of a prescribed imaging region including an object;
shape detecting means for detecting a shape of the object based on the image obtained by the imaging means;
operation mode selecting means for selecting a prescribed operation mode based on a detection result of the object shape detecting means;
distance detecting means for detecting a distance between the imaging means and the object; and
parameter adjusting means for adjusting a value of at least one parameter used in the prescribed operation mode to obtain an adjusted value according to the distance detected by the distance detecting means.

18. The non-contact information input device as recited in claim 17, wherein
the shape detecting means is configured and arranged to detect a shape of a hand of the user within the prescribed imaging region.
